(19) United States
(12) Patent Application Publication
(10) Pub. No.: US 2018/0015408 A1
(43) Pub. Date: Jan. 18, 2018

(54) FOUR-AXIAL-FINS FIXED BED REACTOR FOR USE WITH CALCIUM ALUMINATE CARBONATES CO2 SORBENTS

(71) Applicant: Institute of Nuclear Energy Research, Atomic Energy Council, Executive Yuan, R.O.C, Taoyuan City (TW)

(72) Inventors: Ching-Tsung Yu, Taoyuan City (TW); Yen-Cho Chen, Taoyuan City (TW); Huan-Ting Kuo, Taoyuan City (TW); Wen-Jenn Sheu, Taoyuan City (TW); Tsung-Yu Hsieh, Taoyuan City (TW)

(73) Assignee: Institute of Nuclear Energy Research, Atomic Energy Council, Executive Yuan, R.O.C, Taoyuan City (TW)

(21) Appl. No.: 15/281,017

(22) Filed: Sep. 29, 2016

(30) Foreign Application Priority Data
Jul. 15, 2016 (TW) 105122504

(51) Int. Cl. B01D 53/04; B01J 20/04; B01J 20/02; B01J 20/34

(52) U.S. Cl. CPC B01D 53/0462; B01J 20/3483; B01J 20/3433; B01J 20/043; B01J 20/0277; B01D 53/0407; B01J 20/0248; B01D 2253/112; B01D 2253/104; B01D 2257/504

(57) ABSTRACT

A four-axial-fins fixed bed reactor for use with calcium aluminate carbonates CO₂ sorbents is provided. The four-axial-fins fixed bed reactor includes a tubular reactor and a four-axial-fins tube. The tubular reactor has a tubular reactor inner wall. The four-axial-fins tube is disposed in the tubular reactor, wherein the four-axial-fins tube includes a tube and four axial fins. The tube has a tube outer wall. An annular space is formed between the tube and the tubular reactor. The four axial fins extend along the radial direction of the tubular reactor from the tube outer wall to connect the tubular reactor inner wall, wherein the annular space is equally divided by the four axial fins.

### BACKGROUND OF THE INVENTION

### 1. Field of the Invention

The present invention generally relates to a fixed bed reactor. More particularly, the present invention relates to a fixed bed reactor using four-axial-fins to improve the performance of calcium aluminate carbonates CO₂ sorbents. To be specific, the present invention relates to a fixed bed reactor having better desorption at high temperature and lower power consumption.

### 2. Description of the Prior Art

Compared with amine solution and alkaline solution, solid sorbents have high carbon capture capacity, which are suitable, used in high CO₂ concentration and in wide range of temperature, environmentally friendly, and lower power consumption. Therefore, the use of solid sorbents is considered as an important technique to capture CO₂. Materials having CaO as major component, e.g. limestone and calcium oxide, can be used as CO₂ sorbents in high CO₂ concentration and high temperature. The carbon capacity is usually decreased at repeated CO₂ capturing cycle due to sintering under high capture temperature of 600˜850° C. It is found that the stability of high temperature CO₂ capturing can be enhanced by adding elements such as Al, Zr, Ti, and Mg. Besides, modifying CaO with laminated calcium aluminate carbonates is able to increase the carbon capacity and the stability of it, hence to improve the CO₂ capturing performance.

The carbon capture of CO₂ sorbents can be executed by filling the sorbents in a fixed bed reactor, wherein the advantages include low mechanical loss of the sorbents, simple structure, long gas residence time, and better CO₂ capturing regarding mixed gas. Most researches focus on the CO₂ capturing ability of the CO₂ sorbents in a fixed bed reactor, but not much is about the desorption of the CO₂ sorbents in association with the temperature. For example, Dantas et al. (Brazilian Journal of Chemical Engineering, 2011) discussed the simulation research of CO₂ adsorption of zeolite-13 in the range of 25-150° C. Zhou et al. (Aerosol and Air Quality Research, 2014) used simulation to compare the chemical cycle CO₂ decreasing ability of materials such as NiO in fixed bed and fluidized bed at 900° C. Ben-Mansour et al. (Journal of Energy Resources Technology, 2015) used fixed bed to discuss the effect of metal-organic framework (MOF-5) on CO₂ capturing in 50 bars. Liu et al. (Int. J. Chem. React. Eng., 2016) used CFD to compare the CO₂ capturing of K₂CO₃/Al₂O₃ in fluidized bed.

However, since the temperature gradient in the reactor has significant influence on the capturing and desorption of CO₂ in fixed pressure, more consideration should be taken on the temperature uniformity when a fixed bed reactor is used to capture CO₂ in high temperature environment. Taking the research of Li et al. (Fuel Processing Technology, 2008) on the CO₂ capturing in a fixed bed as an example, the temperatures of adsorption and desorption are usually in the range of 650-900° C. After many repeated CO₂ capturing cycle reactions, the CO₂ capturing efficiency usually decreases with more temperature variation. Such temperature variation results easily in the coverage of larger CaCO₃ particles on the surface of the material. The research of Mikulcic et al. (Chemical Engineering Journal, 2012) indicates that when the CaCO₃ particles grow from 5 μm to 50 μm, the desorption time would be 10 times. The influence caused by the temperature variation of the cycle becomes greater with the increase in diameter of the reactor and filing amount of the absorbents, wherein it would make partial material sinter and lower the mechanical strength more easily. Here are some examples. Wang (Ind. Eng. Chem. Res., 2014) filled an 8 mm inner diameter reactor with CaO material and performed 10 runs of CO₂ capturing cycle, which leads to a 63% decline of carbon capacity. Phromprasit et al. (Chemical Engineering Journal, 2016) filled a 15 mm inner diameter small kW scale reactor with MgO/CaO CO₂ sorbents and performed 10 runs of CO₂ capturing cycle, which leaded to a 12% decline of carbon capacity. Skoufa et al. (Energy Procedia, 2016) filled an 18 mm inner diameter reactor with CaO-based CO₂ sorbents and performed 100 runs of CO₂ capturing cycle, which leads to a 13-49% decline of carbon capacity.

Accordingly, there are some disadvantages in prior art.

1. Wet scrubbing performed by using solvent is suitable for room temperature and low CO₂ concentration of 5-15%, but has the shortcomings of large energy penalty, high regeneration energy, small carbon capacity, and being toxic to the environment. Dry scrubbing performed by using dry sorbents, e.g. powders including CaO (limestone, CaCO₃, serpentine, etc.) is unstable, which is used in middle to high temperature CO₂ capturing and suitable for capturing CO₂ having a concentration less than 10% after a combustion process.

2. Most fixed bed reactors are heated by external heaters. As the reactor tube shown in FIG. 1, the temperature variation is greater in the radial direction, wherein the efficiency of CO₂ sorbents is influenced. Sintering easily happens at high temperature position, which makes the CO₂ sorbents become less effective and lowers the circulation stability.

3. A process of raising and lowering temperature is required for a fixed bed reactor to perform adsorption/desorption cycles. If the heat conductance of the fixed bed reactor is poor, it takes more time to raise and lower the temperature in the interior of the reactor, hence the required time for each loop and the energy consumption are increased.

4. Regarding conventional fluidized bed reactor, the gas residence time is short, the CO₂ capturing regarding mixed gas is poor, and the solid particles break easily due to friction. Circular fluidized beds having a carbonation roaster and a calcination roaster are often used in Ca looping capturing systems, wherein the CO₂ sorbents move between the two roasters. However, a large amount of energy is required to move the CO₂ sorbents.

### SUMMARY OF THE INVENTION

An object of the present invention is to provide a fixed bed reactor to overcome the above mentioned issues of prior art. Calcium aluminate carbonates are used as CO₂ sorbents. A non-uniform temperature distribution in the interior of the fixed bed caused by poor heat conductance is improved. The CO₂ sorbents are able to perform regeneration/desorption in preferred range of temperature. The sintering of CO₂ sorbents at a location of higher temperature is prevented. Thus, the performance of CO₂ sorbents and the stability of the cycles are maintained. By enhancing the heat conductance in the interior of the fixed bed, the time for each cyclic cycle is shortened, the amount of CO₂ capturing is increased, and the regeneration energy consumption per unit of CO₂ capturing is reduced.

Another object of the present invention is to provide a fixed bed reactor, wherein non-uniform temperature distribution in the interior of the fixed bed caused by poor heat conductance is improved. It is beneficial to develop a larger scale high temperature fixed bed CO₂ capturing reactor system.

Another object of the present invention is to provide a reusable fixed bed reactor, which is convenient in filling material and is able to decrease the internal temperature difference of the reactor for increasing the efficiency of the material. More particularly, the fixed bed reactor of the present invention is reusable, is convenient in filling CO₂ sorbents, and is able to decrease the internal temperature difference of the reactor for increasing the CO₂ capturing efficiency of the CO₂ sorbents.

The fixed bed reactor of the present invention includes a tubular reactor and a heat conducting device. The tubular reactor has a tubular reactor inner wall. The heat conducting device disposed in the tubular reactor and is removable from the tubular reactor. The heat conducting device includes a plurality of heat conducting plates disposed along the axial direction of the tubular reactor and connected to each other. The plurality of heat conducting plates extend outward along the radial direction of the tubular reactor from the interior of the tubular reactor to contact the tubular reactor inner wall.

In one embodiment of the present invention, the fixed bed reactor is for a first material to adsorb a second material and to desorb the same after being heated.

In one embodiment of the present invention, the first material is calcium aluminate carbonates CO₂ sorbents and the second material is CO₂.

In one embodiment of the present invention, the tubular reactor presents a cylinder shape.

In one embodiment of the present invention, the cross section of the heat conducting device perpendicular to the axial direction of the tubular reactor presents a cross shape.

In one embodiment of the present invention, the heat conducting device further includes an inner tube disposed in the center of the tubular reactor along the axial direction of the tubular reactor. The inner tube has an inner tube outer wall, wherein one of two opposite side edges of each heat conducting plate contacts the tubular reactor inner wall and the other of the two opposite side edges connects the inner tube outer wall.

In one embodiment of the present invention, there are four heat conducting plates, wherein there is a 90 degrees angle between the adjacent heat conducting plates.

In one embodiment of the present invention, the inner radius of the tubular reactor is 50.8 mm, wherein the inner radius and the thickness of the inner tube are respectively 18.5 mm and 4 mm, wherein the thickness of the plurality of heat conducting plates is 4 mm, wherein the length of the tubular reactor, the length of the inner tube, and the length of the plurality of heat conducting plates are 500 mm.

In one embodiment of the present invention, the radius of the tubular reactor is in the range of 2.14 to 4.75 times the radius of the inner tube.

In one embodiment of the present invention, an annular space is formed between the inner tube and the tubular reactor.

In one embodiment of the present invention, the fixed bed reactor is a four-axial-fins fixed bed reactor for use with calcium aluminate carbonates CO₂ sorbents, which includes a tubular reactor and a four-axial-fins tube. The tubular reactor has a tubular reactor inner wall. The four-axial-fins tube is disposed in the tubular reactor, wherein the four-axial-fins tube includes a tube and four axial fins. The tube has a tube outer wall, wherein an annular space is formed between the tube and the tubular reactor. The four axial fins extend along the radial direction of the tubular reactor from the tube outer wall to connect the tubular reactor inner wall, wherein the annular space is equally divided by the four axial fins.

### BRIEF DESCRIPTION OF THE DRAWINGS

FIG. 1 is a schematic perspective view of a conventional tube reactor;

FIG. 2A is a cross sectional view according to one embodiment of the present invention;

FIG. 2B is a schematic view according to one embodiment of the present invention;

FIG. 2C is an exploded view according to one embodiment of the present invention;

FIGS. 3A and 3B are cross sectional views according to different embodiments of the present invention;

FIGS. 4A and 4B are perspective views according to one embodiment of the present invention further including an inner tube;

FIG. 5 is a perspective view according to the preferred embodiment of the present invention;

FIG. 6 is a flow chart of performing a simulation according to one embodiment of the present invention;

FIG. 7 is a schematic view showing the dimension of components of the present invention;

FIG. 8 is a schematic view showing the simulation result of radial temperature distribution of the present invention;

FIG. 9 is a schematic view showing the simulation result of desorption of the present invention and the prior art at different temperatures.

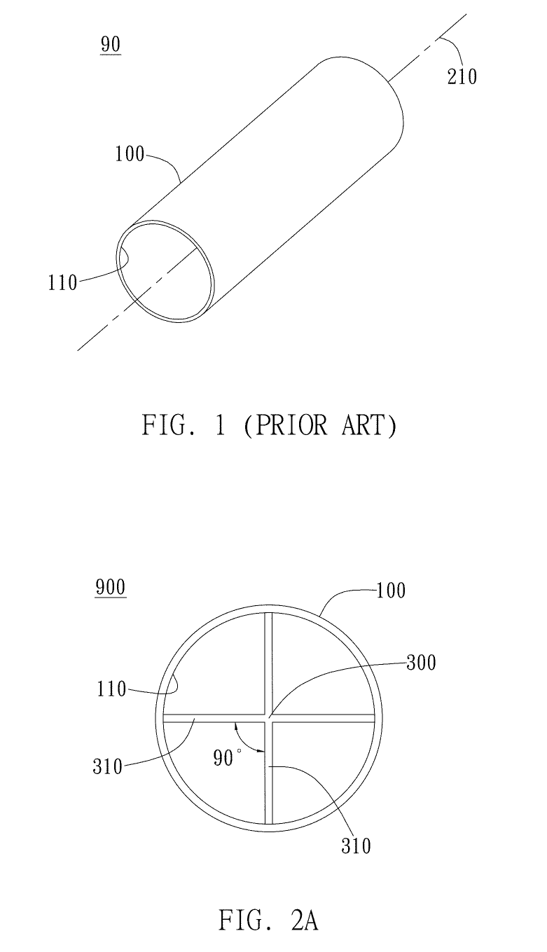

### DETAILED DESCRIPTION OF THE PREFERRED EMBODIMENT

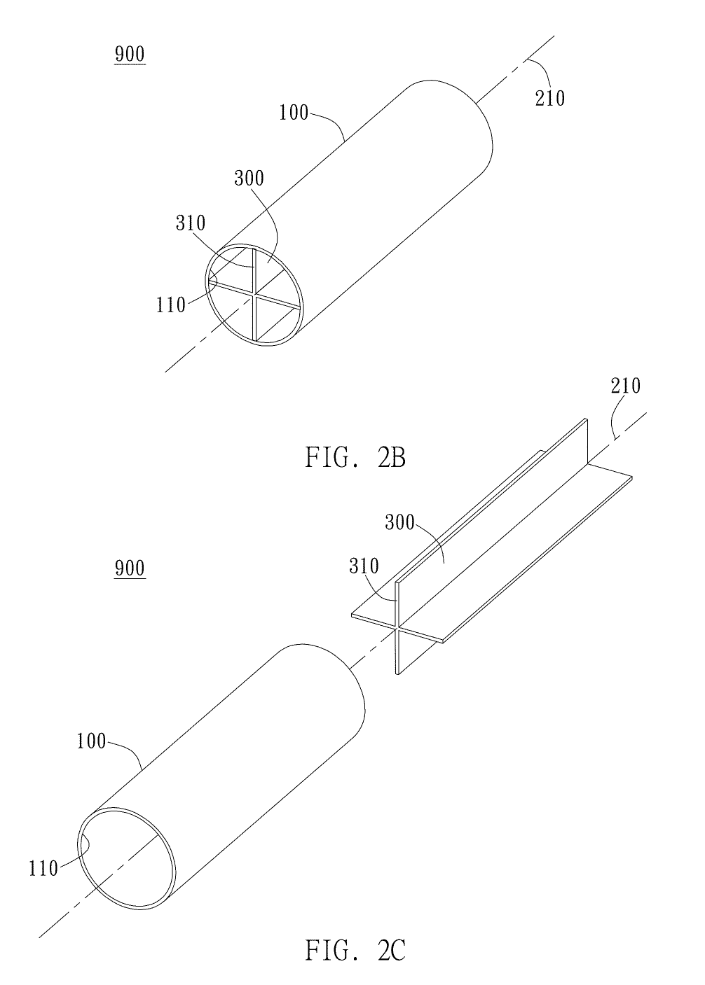

As the embodiment shown in FIGS. 2A to 2C, the fixed bed reactor 900 of the present invention includes a tubular reactor 100 and a heat conducting device 300. The tubular reactor 100 has a tubular reactor inner wall 110. As shown in FIG. 2C, the heat conducting device 300 is disposed in the tubular reactor 100 and is removable from the tubular reactor 100. The heat conducting device 300 includes a plurality of heat conducting plates 310 disposed along the axial direction 210 of the tubular reactor 100 and connected to each other. The plurality of heat conducting plates 310 extend outward along the radial direction of the tubular reactor 100 from the interior of the tubular reactor 100 to contact the tubular reactor inner wall 110. More particularly, the heat conducting device 300 has a size that makes heat conducting plates 310 engage the tubular reactor inner wall 110. In other words, the heat conducting plates 300 fit closely with the tubular reactor 100. In different embodiments, however, for the convenience of fixing and operation, grooves can be disposed on the tubular reactor inner wall 110 for the heat conducting plates 310 to be inserted therein.

As the embodiment shown in FIGS. 2A to 2C, taking a different point of view, the fixed bed reactor 900 includes a tubular reactor 100 and a heat conducting device 300. The tubular reactor 100 has a tubular reactor inner wall 110. The tubular reactor 100 preferably presents cylinder shape, but not limited thereto. The heat conducting device 300 is disposed in the tubular reactor 100 and is removable from the tubular reactor 100. The heat conducting device 300 includes a plurality of heat conducting plates 310 disposed along the axial direction 210 of the tubular reactor 100 and connected to each other. The plurality of heat conducting plates 310 extend along the radial direction of the tubular reactor 100 from the tubular reactor inner wall 110 toward the interior of the tubular reactor 100.

Since the heat conducting plates 310 of the heat conducting device 300 connect the tubular reactor inner wall 110, the heat conducting device 300 helps to transfer the heat received by the tubular reactor 100 to the interior of the tubular reactor 100. Thus, the heat conduction efficiency and temperature uniformity are increased to improve the reaction efficiency of the reactants in the tubular reactor 100. On the other hand, because the heat conducting device 300 is removably disposed in the tubular reactor 100, the heat conducting device 300 can be removed from the tubular reactor 100 after the fixed bed reactor 900 is used. Hence, it is convenient to change the reactants in the tubular reactor 100. More particularly, after the heat conducting device 300 is removed from the tubular reactor 100, both the heat conducting device 300 and the tubular reactor 100 are more easily to be cleaned to remove reaction waste. This ensures a complete filling of fresh reactants after reassembling the fixed bed reactor 900. In the preferred embodiment, the heat conducting device 300 is made of copper. In different embodiments, however, the heat conducting device 300 can be made of other materials having good heat conductance.

In one embodiment, the fixed bed reactor 900 is for a first material to adsorb a second material and to desorb the same after being heated. More particularly, the first material is calcium aluminate carbonates CO₂ sorbents and the second material is CO₂. Since the CO₂ adsorption/desorption efficiency of calcium aluminate carbonates CO₂ sorbents is greatly influenced by temperature, good heat conduction efficiency and temperature uniformity in the tubular reactor 100 can improve the CO₂ adsorption/desorption efficiency of calcium aluminate carbonates CO₂ sorbents.

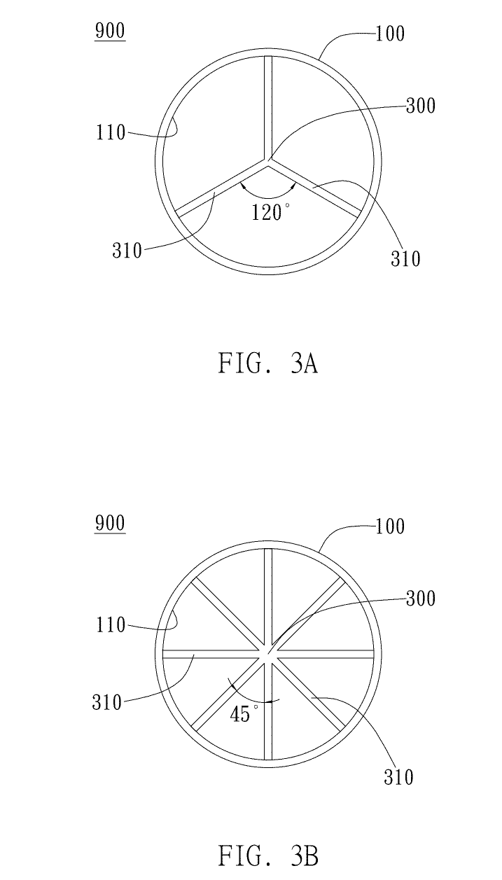

As the embodiment shown in FIGS. 2A to 2C, the cross section of the heat conducting device 300 perpendicular to the axial direction 210 of the tubular reactor 100 presents a cross shape. More particularly, in this embodiment, the fixed bed reactor 900 includes four heat conducting plates 310, wherein there is a 90 degrees angle between the adjacent heat conducting plates 310. In different embodiments, however, the heat conducting device 300 can present different shapes, wherein the angel between the adjacent heat conducting plates 310 can be other than 90°. As the embodiment shown in FIG. 3A, the cross section of the heat conducting device 300 perpendicular to the axial direction of the tubular reactor 100 presents a three-pointed-star shape, wherein the heat conducting device 300 has fewer heat conducting plates 310 to decrease the material and manufacturing cost. As the embodiment shown in FIG. 3B, the cross section of the heat conducting device 300 perpendicular to the axial direction of the tubular reactor 100 presents an eight-pointed-star shape, wherein the heat conducting device 300 has more heat conducting plates 310 to further improve the heat conduction efficiency and temperature uniformity in the tubular reactor 100.

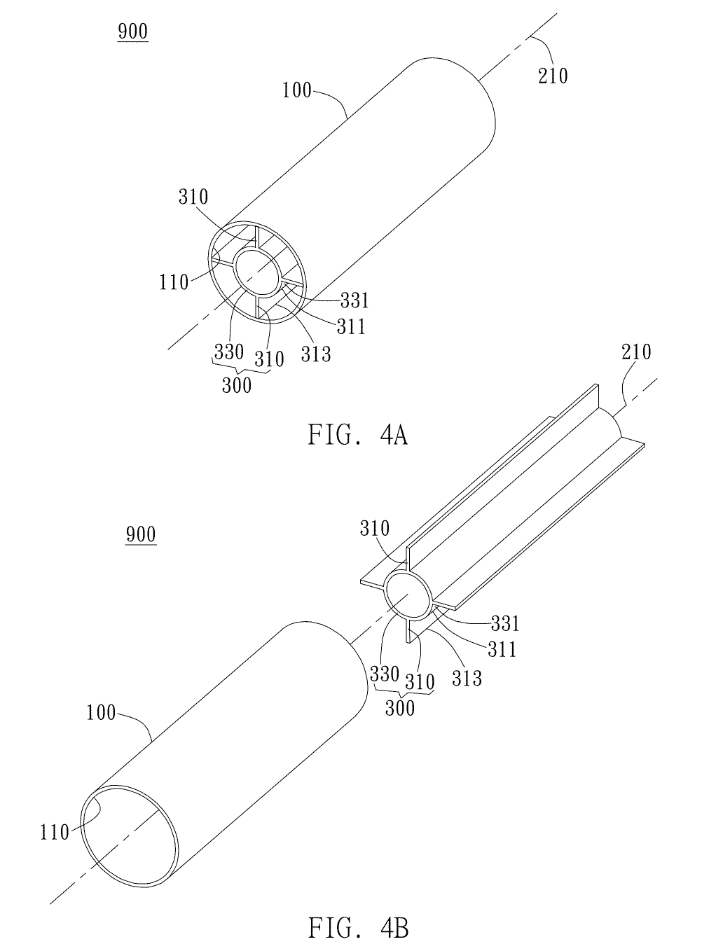

As a different embodiment shown in FIG. 4A, the heat conducting device 300 further includes an inner tube 330 disposed in the center of the tubular reactor 100 along the axial direction 210 of the tubular reactor 100. An annular space is formed between the inner tube 330 and the tubular reactor 100. The inner tube 330 has an inner tube outer wall 331, wherein a side edge 311 of the heat conducting plate 310 contacts the tubular reactor inner wall 110 and a side edge 313 of the heat conducting plate 310 contacts the inner tube outer wall 331. More particularly, as the embodiment shown in FIG. 4B, the heat conducting plate 310 is preferably welded on the inner tube outer wall 331 with the side edge 311. In different embodiments, however, the heat conducting plate 310 can be fixed on the inner tube outer wall 331 by screwing, engaging, etc.

With the inner tube 330, the mechanical strength of the heat conducting device 300 is increased, wherein the deformation of the heat conducting plate 310 is decreased. Accordingly, it prevents the heat conducting device 300 from deforming when being removed from the tubular reactor 100. Besides, the inner tube 330 further improves the heat conduction efficiency and temperature uniformity in the tubular reactor 100.

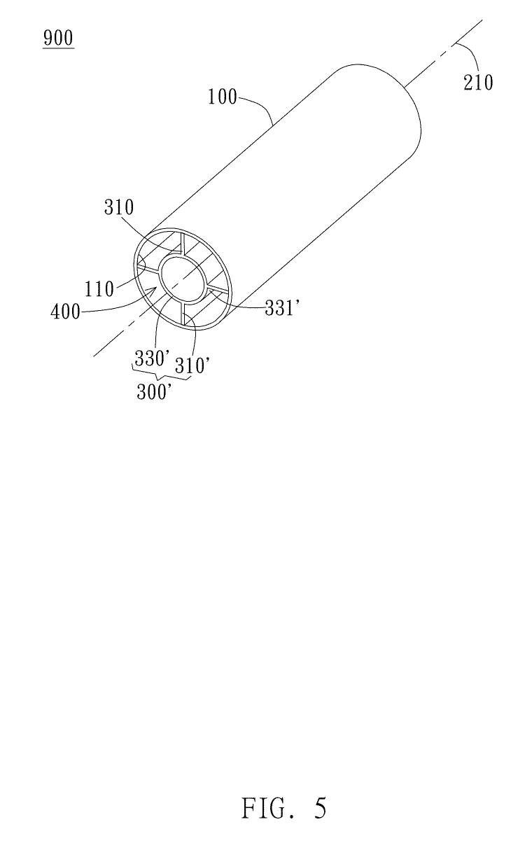

Taking a different point of view, as the embodiment shown in FIG. 5, the fixed bed reactor 900 of the present invention is a four-axial-fins fixed bed reactor for use with calcium aluminate carbonates CO₂ sorbents, which includes a tubular reactor 100 and a four-axial-fins tube 300′. The tubular reactor 100 has a tubular reactor inner wall 110. The four-axial-fins tube 300′ is disposed in the tubular reactor 100, wherein the four-axial-fins tube 300′ includes a tube 330′ and four axial fins 310′. The tube 330′ has a tube outer wall 331′, wherein an annular space 400 is formed between the tube 330′ and the tubular reactor 100. The four axial fins 310′ extend along the radial direction of the tubular reactor 100 from the tube outer wall 331′ to connect the tubular reactor inner wall 110, wherein the annular space 400 is equally divided by the four axial fins 310′. Thus, the heat conduction is more uniform.

To confirm the usefulness of the present invention, a computer simulation is performed.

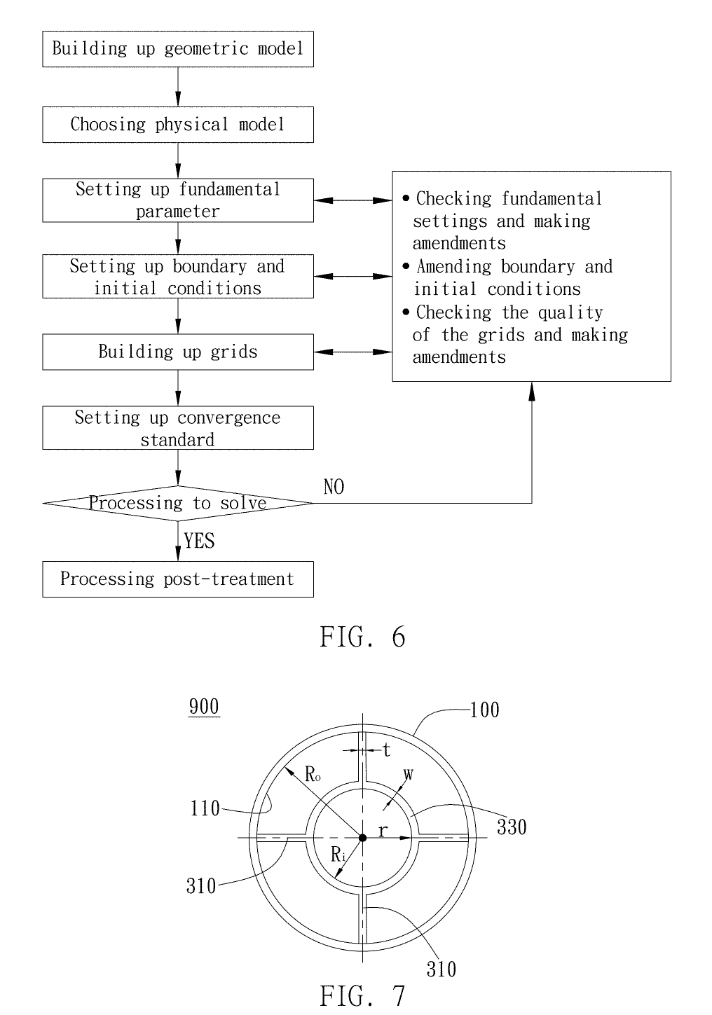

The software to perform the simulation is COMSOL 5.0 (COMSOL INC., USA), which calculates with Finite Element Method. The flow chart of performing the simulation is shown in FIG. 6. As shown in FIG. 7, the inner radius Rₒ of the tubular reactor 100 is 50.8 mm; the inner radius Rᵢ and the thickness W of the inner tube are respectively 18.5 mm and 4 mm; the thickness t of each heat conducting plate is 4 mm. Preferably, the radius of the tubular reactor is in the range of 2.14 to 4.75 times the radius of the inner tube. As shown in FIG. 4A, the length of the tubular reactor, the length of the inner tube, and the length of the plurality of heat conducting plates are 500 mm. At first, a geometric model is built up. Different physical models (free and porous medium flow, porous medium heat conductance) must be coupled in the simulation process. Fundamental parameters (basic thermodynamic properties, chemical reaction rate, etc.) and boundary and initial conditions (temperature, pressure, gas velocity, etc.) are set up then. Suitable grids and convergence standard are built up to obtain a solution.

The Governing equations of the mass, momentum, and energy of the fluid in the reactor are respectively:

$$\begin{matrix} ∇ ( ρ V ) = 0 & ( 1 ) \\ \frac{1}{{ɛ}^{2}} ∇ \cdot ( ρ VV ) = ∇ \cdot [ - pI + \frac{μ}{ɛ} ( ∇ V + {( ∇ V )}^{T} ) - \frac{2 μ}{3 s} I ∇ \cdot V ] - \frac{μ}{{k}_{br}} V & ( 2 ) \\ ɛ ∇ \cdot ( ρ {C}_{p} VT ) = ∇ \cdot ( {λ}_{s} ∇ T ) + Q & ( 3 )\end{matrix}$$

wherein V is velocity vector (u, v, w); ρ is fluid density; is porosity; μ is viscosity; p is pressure; Cₚ is specific heat capacity; T is temperature; Q is energy source term resulted by chemical reaction; λₑ is effective thermal conductivity; k_{br} is penetration rate.

The boundary conditions of the Governing equations are:

### (1) The Inlet of the Reactor

u=uᵢₙ,T=Tᵢₙ (4)

### (2) The Outlet of the Reactor

$$\frac{\partial V}{\partial Z} = \frac{\partial T}{\partial Z} = 0 , p = {p}_{out} \qquad ( 5 )$$

### (3) The Solid Side Walls of the Inlet and Outlet of the Reactor

∇T=0 (6)

The side walls are assumed adiabatic.

### (4) The Interface Between the Gas and the Solid Wall

$$V = 0 , {λ}_{e} \frac{\partial T}{\partial r} = {λ}_{c} \frac{\partial {T}_{c}}{\partial r} \qquad ( 7 )$$

On the interface, No-slip condition is appointed, wherein λ_{c} and T_{c} in the equations are respectively thermal conductivity and temperature of the solid wall.

### (5) Heating Wall

$$V = 0 , T = {T}_{c} , {λ}_{e} \frac{\partial T}{\partial r} = {λ}_{c} \frac{\partial {T}_{c}}{\partial r} \qquad ( 8 )$$

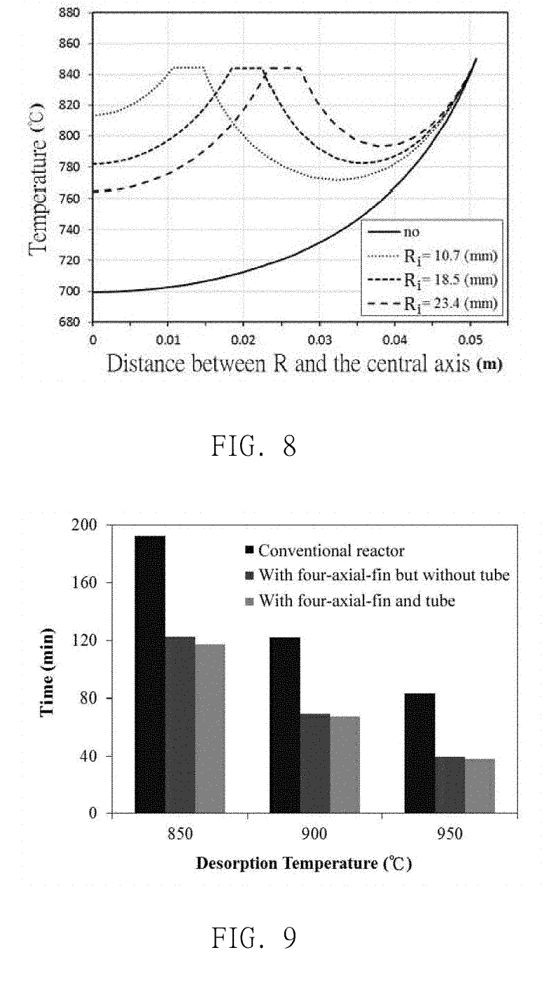

In the present invention, the size of the internal tube can be adjusted. Under the above described desorption conditions, radial temperature distribution simulation on the central cross section of the fixed bed reactor are performed with different sizes of internal tubes, wherein the simulation results are shown in FIG. 8. As shown in FIG. 8, when desorption temperature is 850° C., the preferred inner radius Rᵢ of the inner tube is 18.5 mm, which has the smallest temperature difference with respect to the setting desorption temperature, i.e. 68° C. (=850° C.−782° C.). The maximum temperature difference is lowed about 45.4% (=68° C./(850° C.−700° C.)*100%). The average temperature in the tube is raised from 758° C. to 809° C. The non-uniform temperature distribution is effectively improved to enhance the adsorption/desorption efficiency of the CO₂ sorbents.

On the other hand, FIG. 9 illustrates the simulation results of desorption time (based on 90%) of prior art, the present invention with four-axial-fins but without inner tube, and the present invention with both four-axial-fins and inner tube at desorption temperatures of 850° C., 900° C., and 950° C. As shown in FIG. 9, taking 90% CO₂ desorption as the base, compared with prior art, the desorption time of the reactor in the present invention having inner tube and fins at desorption temperatures of 850° C., 900° C., and 950° C. are decreased respectively by 39%, 44%, and 53%. Moreover, regarding desorption time, that of the prior art is longer than that of the fixed bed reactor of the present invention with four-axial-fins but without inner tube, and further longer than that of the fixed bed reactor of the present invention with both four-axial-fins and inner tube (Rᵢ is 18.5 mm). Accordingly, regarding the desorption efficiency, that of the present invention with both four-axial-fins and inner tube (Rᵢ is 18.5 mm) is better than that of the fixed bed reactor of the present invention with four-axial-fins but without inner tube, and further better than that of the prior art.

Although the preferred embodiments of the present invention have been described herein, the above description is merely illustrative. Further modification of the invention herein disclosed will occur to those skilled in the respective arts and all such modifications are deemed to be within the scope of the invention as defined by the appended claims.

What is claimed is:

1. A four-axial-fins fixed bed reactor for use with calcium aluminate carbonates CO₂ sorbents, comprising:
a tubular reactor having a tubular reactor inner wall; and
a four-axial-fins tube disposed in the tubular reactor, including:
a tube having a tube outer wall, wherein an annular space is formed between the tube and the tubular reactor;
four axial fins extending along the radial direction of the tubular reactor from the tube outer wall to connect the tubular reactor inner wall, wherein the annular space is equally divided by the four axial fins.

2. A fixed bed reactor, comprising:
a tubular reactor having a tubular reactor inner wall; and
a heat conducting device disposed in the tubular reactor, wherein the heat conducting device is removable from the tubular reactor, wherein the heat conducting device includes a plurality of heat conducting plates disposed along the axial direction of the tubular reactor and connected to each other, wherein the plurality of heat conducting plates extend outward along the radial direction of the tubular reactor from the interior of the tubular reactor to contact the tubular reactor inner wall.

3. The fixed bed reactor of claim 2, wherein the fixed bed reactor is for a first material to adsorb a second material and to desorb the same after being heated.

4. The fixed bed reactor of claim 3, wherein the first material is calcium aluminate carbonates CO₂ sorbents and the second material is CO₂.

5. The fixed bed reactor of claim 2, wherein the cross section of the heat conducting device perpendicular to the axial direction of the tubular reactor presents a cross shape.

6. The fixed bed reactor of claim 2, wherein the heat conducting device further includes an inner tube disposed in the center of the tubular reactor along the axial direction of the tubular reactor, wherein the inner tube has an inner tube outer wall, wherein one of two opposite side edges of each heat conducting plate contacts the tubular reactor inner wall and the other of the two opposite side edges connects the inner tube outer wall.

7. The fixed bed reactor of claim 6, wherein there are four heat conducting plates, wherein there is a 90 degrees angle between the adjacent heat conducting plates.

8. The fixed bed reactor of claim 6, wherein the inner radius of the tubular reactor is 50.8 mm, wherein the inner radius and the thickness of the inner tube are respectively 18.5 mm and 4 mm, wherein the thickness of the plurality of heat conducting plates is 4 mm, wherein the length of the tubular reactor, the length of the inner tube, and the length of the plurality of heat conducting plates are 500 mm.

9. The fixed bed reactor of claim 6, wherein the radius of the tubular reactor is in the range of 2.14 to 4.75 times the radius of the inner tube.

10. The fixed bed reactor of claim 6, wherein an annular space is formed between the inner tube and the tubular reactor.
